(19) United States
(12) Patent Application Publication
(10) Pub. No.: US 2017/0007969 A1
(43) Pub. Date: Jan. 12, 2017

(54) SPIRAL-TYPE SEPARATION MEMBRANE ELEMENT

(71) Applicant: NITTO DENKO CORPORATION, Ibaraki-shi, Osaka (JP)

(72) Inventors: Shinya Nishiyama, Ibaraki-shi, Osaka (JP); Junko Nakano, Ibaraki-shi, Osaka (JP); Shinichi Inoue, Ibaraki-shi, Osaka (JP)

(73) Assignee: NITTO DENKO CORPORATION, Ibaraki-shi, Osaka (JP)

(21) Appl. No.: 15/114,182

(22) PCT Filed: Jan. 14, 2015
(86) PCT No.: PCT/JP2015/050731

§ 371 Date: Jul. 26, 2016

(30) Foreign Application Priority Data
Feb. 7, 2014 (JP) 2014-022386

(51) Int. Cl. B01D 63/10; B01D 71/56; C09D 177/10; C08G 69/32; C08G 69/28; B01D 69/12; B01D 67/00

(52) U.S. Cl. CPC B01D 63/10; B01D 69/125; B01D 71/56; B01D 67/0006; C08G 69/32; C08G 69/28; C09D 177/10; B01D 2323/08; B01D 2325/02; B01D 2325/30

(57) ABSTRACT

The objective of the present invention is to provide a spiral-type separation membrane element having superior oxidant resistance relative to the prior art, and a salt-blocking rate that tends not to decrease. The spiral-type separation membrane element is characterized in including: a supply-side flow-path material; a composite semipermeable membrane in which a skin layer is formed on the surface of a porous support, the skin layer containing a polyamide resin obtained by interfacial polymerization of a polyfunctional amine component and a polyfunctional acid halogen component; and a permeation-side flow-path material, wherein the polyfunctional amine component contains N,N′-dimethyl-meta-phenylenediamine and the permeation-side flow-path material has a porosity of 40 to 75%.

### TECHNICAL FIELD

The present invention relates to a spiral-type separation membrane element including a supply-side flow-path material, a composite semipermeable membrane and a permeation-side flow-path material. The spiral-type separation membrane element is suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the element can be used for concentration of active ingredients in foodstuffs usage, for an advanced water treatment, such as removal of harmful component in water purification and sewage usage etc. Moreover, the element can be used for waste water treatment in oil fields or shale gas fields.

### BACKGROUND ART

Currently, composite semipermeable membranes, in which a skin layer including a polyamide resin obtained by interfacial polymerization of a polyfunctional amine and a polyfunctional acid halide is formed on a porous support, have been proposed (Patent Document 1).

In a water treatment process using a composite semipermeable membrane, there is a problem of biofouling that is generated by adhesion of microorganisms in water to the membrane, leading to decrease in water permeability of the membrane. As a method of suppressing such biofouling, there is exemplified, for example, a treatment method for sterilizing microorganisms in water with an oxidizing agent.

However, the composite semipermeable membrane of Patent Document 1 could not be used in the case where a treatment method for sterilizing microorganisms in water with an oxidizing agent was adopted, because the membrane did not have an oxidant resistance (chlorine resistance) that could withstand a long-term continuous operation at a chlorine concentration (1 ppm or more as a free chlorine concentration) capable of inhibiting the growth of microorganisms.

Therefore, development of a composite semipermeable membrane having superior oxidant resistance relative to the prior art has been desired.

Further, as a fluid separating element conventionally used in reverse osmosis filtration, ultrafiltration, microfiltration, or the like, for example, there is known a spiral-type separation membrane element provided with a unit including a supply-side flow-path material to guide a supply-side fluid to the surface of a separation membrane, a separation membrane to separate the supply-side fluid, and a permeation-side flow-path material to guide to a porous center tube the permeation-side fluid separated from the supply-side fluid having passed through the separation membrane, said unit being wound in a spiral form around the center tube (Patent Documents 2 and 3).

Such a spiral-type separation membrane element is generally produced by stacking a permeation-side flow-path material onto a material obtained by disposing a supply-side flow-path material between two sheets of a two-folded separation membrane, applying an adhesive on the separation membrane peripheral parts (three sides) so as to form sealing parts for preventing the supply-side fluid and the permeation-side fluid from being mixed with each other, thereby to fabricate a separation membrane unit, winding one of the unit or a plurality of the units in a spiral form around the center tube, and further sealing the separation membrane peripheral parts.

When the composite semipermeable membrane was used as a separation membrane for such a spiral-type separation membrane element, there was a problem such that the skin layer was susceptible to be damaged, leading to a gradual decrease in the salt-blocking rate because the composite semipermeable membrane during water treatment was pressurized from the side of the supply-side flow-path material.

### PRIOR ART DOCUMENTS

### Patent Documents

Patent Document 1: JP-A-2005-103517

Patent Document 2: JP-A-2000-354743

Patent Document 3: JP-A-2006-68644

### SUMMARY OF THE INVENTION

### Problems to be Solved by the Invention

The objective of the present invention is to provide a spiral-type separation membrane element having superior oxidant resistance and having a salt-blocking rate that is less likely to decrease.

### Means for Solving the Problems

The present inventors have made extensive and intensive studies with a view to achieving the above object, and as a result, have found that a spiral-type separation membrane element having superior oxidant resistance and having a salt-blocking rate that is less likely to decrease can be obtained by using N,N′-dimethyl-meta-phenylenediamine as a raw material of the skin layer and adjusting a porosity of the permeation-side flow-path material to 40 to 75%. The present invention has been completed based on these findings.

That is, the present invention relates to a spiral-type separation membrane element including: a supply-side flow-path material; a composite semipermeable membrane in which a skin layer is formed on the surface of a porous support, the skin layer containing a polyamide resin obtained by interfacial polymerization of a polyfunctional amine component and a polyfunctional acid halogen component; and a permeation-side flow-path material, wherein

the polyfunctional amine component contains N,N′-dimethyl-meta-phenylenediamine and

the permeation-side flow-path material has a porosity of 40 to 75%.

The present invention is characterized by using N,N′-dimethyl-meta-phenylenediamine as a polyfunctional amine component. As a result, a skin layer which is excellent in oxidant resistance can be obtained. However, the skin layer made by using N,N′-dimethyl-meta-phenylenediamine as the polyfunctional amine component received physical damage more easily than skin layers prepared by using other polyfunctional amine components, and was likely to form a depression during water treatment. The present inventors have found that a depression formation in the skin layer is unlikely to occur by using a permeation-side flow-path material with a porosity of 40 to 75%, even when a high pressure is applied to the skin layer during water treatment.

If the porosity of the permeation-side flow-path material is less than 40%, the depression formation in the skin layer can be effectively suppressed, but the porosity of less than 40% is not preferable because a permeation flux is greatly reduced. On the other hand, if the porosity of the permeation-side flow-path material is more than 75%, it is impossible to support the pressure exerted on the skin layer from the back (porous support side), because of which the depression formation in the skin layer cannot be effectively suppressed.

The permeation-side flow-path material is preferably a tricot knit fabric. The use of tricot knit fabric makes it possible to more effectively suppress the depression formation in the skin layer.

### Effect of the Invention

Since the spiral-type separation membrane element of the present invention has superior oxidant resistance, the element can also be used when employing a treatment method for sterilizing microorganisms in water with an oxidizing agent. Conventionally, pretreatment by using an ultrafiltration membrane or a microfiltration membrane has been performed so as to remove microorganisms in water. However, use of the spiral-type separation membrane element of the present invention makes it possible to omit such a pretreatment or simplify the pretreatment. Therefore, the water treatment method using the spiral-type separation membrane element of the present invention is more advantageous compared to the conventional water treatment method from the viewpoint of cost and ecological footprint. In addition, since the spiral-type separation membrane element of the present invention is less likely to form a depression in the skin layer during water treatment, the spiral-type separation membrane element hardly decreases a salt-blocking rate even after being used for a long period of time.

### Mode for Carrying Out the Invention

Hereinafter, the embodiments of the present invention will be described. The spiral-type separation membrane element of the present invention including: a supply-side flow-path material; a composite semipermeable membrane in which a skin layer is formed on the surface of a porous support, the skin layer containing a polyamide resin obtained by interfacial polymerization of a polyfunctional amine component and a polyfunctional acid halogen component; and a permeation-side flow-path material.

First, the composite semipermeable membrane used in the present invention will be described in detail.

In the present invention, N,N′-dimethyl-meta-phenylenediamine as a polyfunctional amine component is used. It is preferred to use only N,N′-dimethyl-meta-phenylenediamine as the polyfunctional amine component, but the following aromatic, aliphatic, or alicyclic polyfunctional amines may be used in combination with the N,N′-dimethyl-meta-phenylenediamine within a range not to impair the effects of the present invention.

The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene, 2,4-diaminoanisole, amidol, xylylene diamine etc. These polyfunctional amines may be used independently, and two or more kinds may be used in combination.

The aliphatic polyfunctional amines include, for example, ethylenediamine, propylenediamine, tris(2-aminoethyl)amine, N-phenyl-ethylenediamine, etc. These polyfunctional amines may be used independently, and two or more kinds may be used in combination.

The alicyclic polyfunctional amines include, for example, 1,3-diaminocyclohexane, 1,2-diaminocyclohexane, 1,4-diaminocyclohexane, piperazine, 2,5-dimethylpiperazine, 4-aminomethylpiperazine, etc. These polyfunctional amines may be used independently, and two or more kinds may be used in combination.

In the case where N,N′-dimethyl-meta-phenylenediamine and the polyfunctional amine are used in combination, it is preferable to use N,N′-dimethyl-meta-phenylenediamine in an amount of 85% by weight or more, more preferably 95% by weight or more, relative to the total amount of the polyfunctional amine components.

The polyfunctional acid halide component represents polyfunctional acid halides having two or more reactive carbonyl groups.

The polyfunctional acid halides include aromatic, aliphatic, and alicyclic polyfunctional acid halides.

The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc.

The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc.

The alicyclic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc.

These polyfunctional acid halides may be used independently, and two or more kinds may be used in combination. In order to obtain a skin layer having higher salt-blocking property, it is preferred to use aromatic polyfunctional acid halides. In addition, it is preferred to form a cross linked structure using polyfunctional acid halides having trivalency or more as at least a part of the polyfunctional acid halide components.

Furthermore, in order to improve performance of the skin layer including the polyamide resin, polymers such as polyvinyl alcohol, polyvinylpyrrolidone, and polyacrylic acids etc., and polyhydric alcohols, such as sorbitol and glycerin, may be copolymerized.

The porous support for supporting the skin layer is not especially limited as long as it has a function for supporting the skin layer. Materials for formation of the porous support include various materials, for example, polyarylether sulfones, such as polysulfones and polyether sulfones; polyimides; polyvinylidene fluorides; etc., and polysulfones and polyarylether sulfones are especially preferably used from a viewpoint of chemical, mechanical, and thermal stability. The thickness of this porous support is usually approximately 25 to 125 μm, and preferably approximately 40 to 75 μm, but the thickness is not necessarily limited to them. The porous support may be reinforced with backing by cloths, nonwoven fabric, etc.

The porous support may have a symmetrical structure or an asymmetrical structure. However, the asymmetrical structure is preferred from the viewpoint of satisfying both of supporting function and liquid permeability of the skin layer. The average pore diameter of the skin layer formed side of the porous support is preferably from 0.01 to 0.5 μm.

Further, an epoxy resin porous sheet may be used as the porous support. The average pore diameter of the epoxy resin porous sheet is preferably from 0.01 to 0.4 μm.

Processes for forming the skin layer including the polyamide resin on the surface of the porous support is not in particular limited, and any publicly known methods maybe used. For example, the publicly known methods include an interfacial condensation method, a phase separation method, a thin film application method, etc. The interfacial condensation method is a method, wherein an amine aqueous solution containing a polyfunctional amine component, an organic solution containing a polyfunctional acid halide component are forced to contact together to forma skin layer by an interfacial polymerization, and then the obtained skin layer is laid on a porous support, and a method wherein a skin layer of a polyamide resin is directly formed on a porous support by the above-described interfacial polymerization on a porous support. Details, such as conditions of the interfacial condensation method, are described in Japanese Patent Application Laid-Open No. S58-24303, Japanese Patent Application Laid-Open No. H01-180208, and these known methods are suitably employable.

In the present invention, it is preferred to forma skin layer by an interfacial polymerization method including forming a coating layer of an amine solution containing N,N′-dimethyl-meta-phenylenediamine on a porous support and bringing an organic solution containing a polyfunctional acid halide component into contact with the coating layer of the amine solution.

As the solvent for the amine solution, there are exemplified alcohols such as ethylene glycol, isopropyl alcohol, and ethanol, and a mixed solvent of these alcohols with water. In particular, it is preferable to use ethylene glycol as the solvent for the amine solution.

In the interfacial polymerization method, although the concentration of the polyfunctional amine component in the amine solution is not in particular limited, the concentration is preferably 0.1 to 5% by weight, and more preferably 0.5 to 2% by weight. Less than 0.1% by weight of the concentration of the polyfunctional amine component may easily cause defect such as pinhole. in the skin layer, leading to tendency of deterioration of salt-blocking property. On the other hand, the concentration of the polyfunctional amine component exceeding 5% by weight allows easy permeation of the polyfunctional amine component into the porous support to be an excessively large thickness and to raise the permeation resistance, likely giving deterioration of the permeation flux.

Although the concentration of the polyfunctional acid halide component in the organic solution is not in particular limited, it is preferably 0.01 to 5% by weight, and more preferably 0.05 to 3% by weight. Less than 0.01% by weight of the concentration of the polyfunctional acid halide component is apt to make the unreacted polyfunctional amine component remain, to cause defect such as pinhole in the skin layer, leading to tendency of deterioration of salt-blocking property. On the other hand, the concentration exceeding 5% by weight of the polyfunctional acid halide component is apt to make the unreacted polyfunctional acid halide component remain, to be an excessively large thickness and to raise the permeation resistance, likely giving deterioration of the permeation flux.

The organic solvents used for the organic solution is not especially limited as long as they have small solubility to water, and do not cause degradation of the porous support, and dissolve the polyfunctional acid halide component. For example, the organic solvents include saturated hydrocarbons, such as cyclohexane, heptane, octane, and nonane, halogenated hydrocarbons, such as 1,1,2-trichlorofluoroethane, etc. These organic solvents may be used singly or may be used as a mixed solvent of two or more thereof. Among these, it is preferable to use an organic solvent having a boiling point of 130 to 250° C.; it is more preferable to use an organic solvent having a boiling point of 145 to 250° C.; it is even more preferable to use an organic solvent having a boiling point of 160 to 250° C.; and it is particularly preferable to use an organic solvent having a boiling point of 180 to 250° C., in view of improving the oxidant resistance of the composite semipermeable membrane.

The organic solvent having such a boiling point includes, for example, hydrocarbon solvents, and may be used alone or may be used as a mixture thereof. In the case of a mixture, the average value of the distillation temperature range is defined as the boiling point. Examples of such an organic solvent include, for example, saturated hydrocarbons such as nonane, decane, undecane, dodecane, and tridecane; isoparaffin-based solvents such as IP Solvent 1620, IP Clean LX, and IP Solvent 2028; and naphthene-based solvents such as Exxsol D30, Exxsol D40, Exxsol D60, Exxsol D80, Naphtesol 160, Naphtesol 200, and Naphtesol 220. Of these, the isoparaffin-based solvents or the naphthene-based solvents are preferable, and from the viewpoint of improving the chlorine resistance, the naphthene-based solvents are particularly preferred.

Various kinds of additives may be added to the amine solution or the organic solution in order to provide easy film production and to improve performance of the composite semipermeable membrane to be obtained. The additives include, for example, surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts; compounds having a solubility parameter of 8 to 14 (cal/cm³)^{1/2} described in Japanese Patent Application Laid-Open No. H08-224452.

The period of time after application of the amine solution until application of the organic solution on the porous support depends on the composition and viscosity of the amine solution, and on the pore size of the surface layer of the porous support, and it is preferably 15 seconds or less, and more preferably 5 seconds or less. Application interval of the solution exceeding 15 seconds may allow permeation and diffusion of the amine solution to a deeper portion in the porous support, and possibly cause a large amount of the residual unreacted polyfunctional amine components in the porous support. In this case, removal of the unreacted polyfunctional amine component that has permeated to the deeper portion in the porous support is probably difficult even with a subsequent membrane washing treatment. Excessive amine solution may be removed after covering by the amine solution on the porous support.

In the present invention, after the contact with the coating layer of amine solution and the organic solution, it is preferred to remove the excessive organic solution on the porous support, and to dry the formed membrane on the porous support by heating at a temperature of 70° C. or more, forming the skin layer. Heat-treatment of the formed membrane can improve the mechanical strength, heat-resisting property, etc. The heating temperature is more preferably 70 to 200° C., and especially preferably 100 to 150° C. The heating period of time is preferably approximately 30 seconds to 10 minutes, and more preferably approximately 40 seconds to 7 minutes.

The thickness of the skin layer formed on the porous support is not in particular limited, and it is usually approximately 0.01 to 100 μm, and preferably 0.1 to 10 μm.

Further, in order to improve the salt-blocking property, water permeability, and oxidant resistance of the composite semipermeable membrane, conventionally known various treatments may be applied. In addition, from the viewpoint of excellent workability and storage stability, the composite semipermeable membrane may be made into the form of a dry type.

The supply-side flow-path material can be used in the known form without any particular limitation, and, for example, net-like materials, mesh-like materials, grooved sheets, or corrugated sheets may be used as the supply-side flow-path material.

In the present invention, a permeation-side flow-path material having a porosity of 40 to 75% is used. The porosity is preferably 50 to 70%, more preferably 55 to 65%. As the permeation-side flow-path material, it is possible to use, for example, a net-like material, a knitted material, a mesh-like material, a grooved sheet, a corrugated sheet, and the like. Of these, it is particularly preferable to use a tricot knit fabric as the permeation-side flow-path material.

The spiral-type separation membrane element of the present invention is produced, for example, by stacking a permeation-side flow-path material onto a material obtained by disposing a supply-side flow-path material between two sheets of a two-folded composite semipermeable membrane; applying an adhesive on the composite semipermeable membrane peripheral parts (three sides) so as to form sealing parts for preventing the supply-side fluid and the permeation-side fluid from being mixed with each other, thereby to prepare a separation membrane unit; winding one of the unit or a plurality of the units in a spiral form around a center tube, and further sealing the separation membrane unit peripheral parts.

### EXAMPLE

The present invention will, hereinafter, be described with reference to Examples, but the present invention is not limited at all by these Examples.

### Example 1

N,N′-Dimethyl-meta-phenylenediamine (3% by weight), sodium lauryl sulfate (0.15% by weight), triethylamine (2.5% by weight), and camphorsulfonic acid (5% by weight) were dissolved in ethylene glycol to prepare an amine solution. In addition, trimesic acid chloride (0.2% by weight) and isophthalic acid chloride (0.4% by weight) were dissolved in Exxsol D30 (manufactured by Exxon Mobil Corporation, distillation range 130 to 160° C., boiling point 148° C.) to prepare an acid chloride solution. Then, the amine solution was applied onto a porous support and the excess amine solution was subsequently removed to form an amine solution coating layer. After that, the acid chloride solution was applied onto the surface of the amine solution coating layer. Then, after removal of the excess solution, the coating layer was held in a hot air dryer of 100° C. for 5 minutes to form a skin layer containing a polyamide-based resin on the porous support, thereby to prepare a composite semipermeable membrane.

Using the Test Unit C40-B (manufactured by Nitto Denko Corporation), a tricot knit fabric with a porosity of 57% as a permeation-side flow-path material is laid and the prepared composite semipermeable membrane is set thereon. Then, an aqueous solution containing 0.15% NaCl and being adjusted to pH 7 with NaOH is brought into contact with the composite semipermeable membrane at 25° C. by giving a pressure difference of 1.5 MPa. A permeation velocity and electric conductivity of the permeated water obtained by this operation were measured, and a permeation flux (m³/m²·d) and a salt-blocking rate (%) were calculated. The correlation (calibration curve) of the NaCl concentration and electric conductivity of the aqueous solution was made beforehand, and the salt-blocking rate was calculated by the following equation.

Salt-blocking rate (%)={1−(NaCl concentration in permeated liquid [mg/L])/(NaCl concentration in supply solution) [mg/L]}×100

### Examples 2 to 7 and Comparative Examples 1 and 2

Using the composite semipermeable membrane prepared in Example 1, a permeation flux and a salt-blocking rate were measured in the same manner as in Example 1, except for using the permeation-side flow-path material that was a tricot knit fabric having a porosity shown in Table 1.

### Reference Examples 1 to 3

A composite semipermeable membrane was prepared in the same manner as in Example 1, except for using meta-phenylenediamine (3% by weight) instead of N,N′-dimethyl-meta-phenylenediamine (3% by weight) in Example 1. Then, using the composite semipermeable membrane thus prepared, a permeation flux and a salt-blocking rate were measured in the same manner as in Example 1, except for using the permeation-side flow-path material that was a tricot knit fabric having a porosity shown in Table 1.

TABLE 1

| | | Porosity | | |
|---|---|---|---|---|
| | | of permea- | Salt- | Permea- |
| | | tion-side | block- | tion |
| | | flow-path | ing | flux (m³/ |
| | Diamine | material (%) | rate (%) | m² · d) |
| Example 1 | N,N′-Dimethyl-meta- | 57 | 95.44 | 0.99 |
| | phenylenediamine | | | |
| Example 2 | N,N′-Dimethyl-meta- | 58 | 95.25 | 1.01 |
| | phenylenediamine | | | |
| Example 3 | N,N′-Dimethyl-meta- | 60 | 94.91 | 1.04 |
| | phenylenediamine | | | |
| Example 4 | N,N′-Dimethyl- | 61 | 94.97 | 1.01 |
| | meta-phenylenediamine | | | |
| Example 5 | N,N′-Dimethyl- | 62 | 94.97 | 1.04 |
| | meta-phenylenediamine | | | |
| Example 6 | N,N′-Dimethyl- | 65 | 92.42 | 1.05 |
| | meta-phenylenediamine | | | |
| Example 7 | N,N′-Dimethyl- | 73 | 90.99 | 1.08 |
| | meta-phenylenediamine | | | |
| Compara- | N,N′-Dimethyl- | 76 | 62.32 | 1.98 |
| tive | meta-phenylenediamine | | | |
| Example 1 | | | | |
| Compara- | N,N′-Dimethyl- | 79 | 59.12 | 2.19 |
| tive | meta-phenylenediamine | | | |
| Example 2 | | | | |
| Reference | Meta-phenylenediamine | 73 | 99.59 | 0.94 |
| Example 1 | | | | |
| Reference | Meta-phenylenediamine | 76 | 99.69 | 0.83 |
| Example 2 | | | | |
| Reference | Meta-phenylenediamine | 79 | 99.66 | 0.83 |
| Example 3 | | | | |

From Table 1, the composite semipermeable membranes prepared in Examples 1 to 7 using N,N′-dimethyl-meta-phenylenediamine as a polyfunctional amine component are found to have superior oxidant resistance. Further, it can be seen that the salt-blocking rate hardly decreases by combination use of the composite semipermeable membrane with the permeation-side flow-path material having a specific porosity. On the other hand, in Comparative Examples 1 and 2, since the permeation-side flow-path materials each having a porosity that was outside the range of the porosity of 40 to 75% were used, the salt-blocking rate was significantly reduced. In the case of the composite semipermeable membranes prepared with use of meta-phenylenediamine as the polyfunctional amine component in Reference Examples 1 to 3, a large difference in the salt-blocking rate was not observed by a difference in the porosity of the permeation-side flow-path materials.

### INDUSTRIAL APPLICABILITY

The spiral-type separation membrane element of the present invention is suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the element can be used for concentration of active ingredients in foodstuffs usage, for an advanced water treatment, such as removal of harmful component in water purification and sewage usage etc. Moreover, the element can be used for waste water treatment in oil fields or shale gas fields.

1. A spiral-type separation membrane element including: a supply-side flow-path material; a composite semipermeable membrane in which a skin layer is formed on the surface of a porous support, the skin layer containing a polyamide resin obtained by interfacial polymerization of a polyfunctional amine component and a polyfunctional acid halogen component; and a permeation-side flow-path material, wherein
the polyfunctional amine component contains N,N′-dimethyl-meta-phenylenediamine and
the permeation-side flow-path material has a porosity of 40 to 75%.

2. The spiral-type separation membrane element according to claim 1, wherein the permeation-side flow-path material is a tricot knit fabric.
